(19) United States
(12) Patent Application Publication
(10) Pub. No.: US 2024/0110823 A1
(43) Pub. Date: Apr. 4, 2024

(54) DISTRIBUTED VIBRATION SENSING OVER OPTICAL FIBERS

(71) Applicant: Teldor Cables & Systems Ltd., Kibbutz Ein Dor (IL)

(72) Inventors: Tuvia LIBERMAN, Kfar-Tavor (IL); David MILLER, Carmiel (IL)

(73) Assignee: Teldor Cables & Systems Ltd., Kibbutz Ein Dor (IL)

(21) Appl. No.: 18/037,367

(22) PCT Filed: Nov. 16, 2021
(86) PCT No.: PCT/IL2021/051359

§ 371 Date: May 17, 2023

(30) Foreign Application Priority Data
Nov. 17, 2020 (IL) 278789

(51) Int. Cl. G01H 9/00; G02B 6/02; G02B 6/255

(52) U.S. Cl. CPC G01H 9/004; G02B 6/02104; G02B 6/02123; G02B 6/2551

(57) ABSTRACT

An optical fiber for use in distributed vibration sensing has perturbations along its length. The perturbations may be applied externally to a mode field diameter of the optical fiber. Alternatively, the perturbations may be applied through the use of fusion splicing of fiber lengths that form the optical fiber.

### RELATED APPLICATION

This application claims the benefit of priority of Israel Patent Application No. 278789 filed on 17 Nov. 2020, the contents of which are incorporated herein by reference in their entirety.

### FIELD AND BACKGROUND OF THE INVENTION

The present invention, in some embodiments thereof, relates to a method and apparatus for distributed vibration sensing and, more particularly, but not exclusively, to a distributed vibration sensing method and apparatus based on installed cables and optical fibers adapted for vibration sensing.

Vibration sensing is used in numerous fields. For example, in the geological field, vibration sensing may be part of earthquake detection or monitoring the activity of volcanoes. In the fields of oil exploration and mining, vibrations may be sent into the ground and require detection to indicate the nature of the ground and the presence of oil, gas and minerals. In the security field, vibration sensing may be used to monitor International borders or the perimeters of sensitive locations. Vibration sensing may be used to monitor the structural integrity of buildings, bridges and other public infrastructure and in traffic management, vibration sensing may be used to sense vehicles and road usage.

Vibrations may be sensed and monitored by placing cables containing optical fibers in the proximity of the source phenomenon to be measured (the measurand), sending light waves through the optical fibers and monitoring the return signals. In order to achieve this, two main methods are known. The first method, based on Bragg's Law, uses expensive specialty fibers onto which intrusive deviations have been implemented. Thus these Bragg gratings are introduced into the fibers, making the fibers useless for any other purpose and thus requiring that dedicated vibration monitoring fibers are used.

Another method uses standard fibers but relies on non-linear optical effects such as Raman or Brillouin scattering. Such effects require sensitive and expensive monitoring equipment to actively detect the return signals and hence monitor vibrations. Certain short-range usage of non-altered standard optical fibers in vibration sensing applications is also known.

Additional background art includes Hicke et al, Sensors 2019 19(19), 4114, which relates to the detection of Rayleigh scattering from perturbations introduced into the core of the optical fiber using femtosecond lasers. The detection system is invasive, in that material modifications are made to the core of the optical fiber, and femtosecond lasers are relatively rare, very expensive and their use is often with highly limited security clearance restrictions.

### SUMMARY OF THE INVENTION

The present embodiments may provide a method, system and apparatus for distributed vibration sensing that concurrently allows for an increased sensitivity range and a reduced cost of distributed vibration sensing over optical fiber. In addition, the fibers used for sensing may be the standard optical fibers used for fiberoptic communication so that the fibers used in the present embodiments may simultaneously serve as part of standard fiber communication networks.

The present embodiments relate to distributed vibration sensing and use optical fibers and the phenomenon of linear Rayleigh scattering to assess reflected signals, where the scattering is affected by perturbations on the coating of the optical fiber or as introduced by fusion splices. The monitoring is passive, meaning that nothing is inserted into or materially altered in the main light path within the fibers. The perturbations are generally external to the core of the fiber (with the exception of the fusion splice method) and do not affect the functional photonic energy that passes through the optical fiber's mode field diameter or alter the material composition of the fiber. That is to say the perturbations are external to the mode field diameter of the fiber. The perturbations cause minute but detectable interferometric patterns that are echoed back in the direction of the light source. These minute patterns are in the order of magnitude of 1×10⁻⁴ dB, therefore significantly smaller by approximately 2 orders of magnitude when compared to the weakening of an optical communication signal normally measured as attenuation (either in dB or length dependent dB/km), and use of the term ‘minute’ herein is to be construed accordingly.

It is noted that the Rayleigh backscattering being monitored for the effects of fiber strain caused by the vibration is interferometric Rayleigh backscattering, and is not to be confused with common Rayleigh backscattering in the standard optical fiber which operates at a different order of magnitude and is a cause of attenuation of the photonic energy in the fiber used for communication signals

Perturbations may be added to the fibers during the manufacturing process, as will be explained in greater detail below.

Using the present embodiments, different sources of vibration may be associated with a different layout or spacing of the perturbations so as to provide a suitable (positive) signal to noise ratio (SNR) for reliable detection. The layout may be obtained empirically for each type of vibration.

According to an aspect of some embodiments of the present invention there is provided an optical fiber for use in distributed vibration sensing, the optical fiber comprising perturbations, the perturbations being imparted either externally to a mode field diameter of the optical fiber or through the use of fusion splicing of fiber lengths to form said optical fiber.

In an embodiment, said perturbations are imparted in groups of at least one perturbation, each group equidistantly spaced along said fiber at a first, inter-group, spacing.

In an embodiment, each group comprises a plurality of equidistant perturbations spaced apart at a second, intragroup, spacing.

In an embodiment, at least one of said inter-group and intragroup spacings is selected to amplify minute interferometric Raleigh scattering.

In an embodiment, at least one of said inter-group spacing and said intragroup spacing is selected using empirical testing to maximize a reflected signal from minute interferometric Rayleigh scattering in the presence of a given vibration.

In an embodiment, the fiber is designed to pick up vibrations from a specific one of the following:

humans, animals, light vehicles, heavy vehicles, light mechanical-engineering activity, heavy mechanical engineering activity, drilling, and geological activity. Each vibration source has a different vibration signature, and is detected with a different optimal spacing of the perturbations, which may be detected empirically for each case as described hereinbelow.

In an embodiment, said imparting of said perturbations comprises printing.

In an embodiment, said perturbations are laser printed.

In an embodiment, said perturbations are imparted into a coating layer of said fiber.

An optical cable may have numerous fibers, one or more of which are fibers having perturbations as discussed herein, so that the cable can be used for standard communication while one or two of the fibers additionally provide the service of vibration detection.

The cable may have two or more fibers detecting vibrations to give redundancy in case of failure of one of the fibers.

According to a second aspect of the present invention there is provided apparatus for detecting vibrations comprising:
at least one optical fiber having perturbations external to a mode field diameter of said optical fiber; and
a detection device configured to detect Rayleigh scattering from said perturbations.

The apparatus may be part of an optical fiber communication network.

According to a third aspect of the present invention there is provided apparatus for detecting vibrations comprising:
at least one optical fiber constructed by splicing together of smaller fibers of predetermined lengths, the optical fiber having perturbations imparted by said fusion splicing; and
a detection device configured to detect Rayleigh scattering from said perturbations.

According to a fourth aspect of the present invention there is provided a method of producing an optical fiber for detection of vibrations from Rayleigh scattering, the method comprising:
coating of a fiber with a primary coating, and
printing perturbations into said primary coating.

In an embodiment, said printing is carried out while said primary coating is still hot from the coating process.

In an embodiment, said printing is carried out while said primary coating is heated following said coating process.

The method may involve printing said perturbations in groups equidistantly spaced along said fiber at a first, inter-group, spacing.

In an embodiment, said printing into said primary coating comprises laser printing.

In the method, each group may have a plurality of equidistant perturbations spaced apart at a second, intragroup, spacing.

According to a fourth aspect of the present invention there is provided a method of producing an optical fiber for detection of vibrations from Rayleigh scattering, the method comprising:
Forming said optical fiber; and
Introducing perturbations into said optical fiber at predetermined spacings by fusion splicing.

The spacings may be selected to amplify minute interferometric Raleigh scattering.

In the method, at least one of said inter-group spacing and said intragroup spacing may be selected using empirical testing to maximize the SNR of a reflected signal from Rayleigh scattering in the presence of a given vibration.

According to a fifth aspect of the present invention there is provided a method of detecting vibrations over an area comprising:
burying in said area at least one optical fiber having perturbations as discussed herein; and
connecting to said optical fiber a Coherent Optical Time Domain Reflectometer (C-OTDR) to detect Rayleigh scattering of light travelling through said optical fiber.

According to a sixth aspect of the present invention there is provided apparatus for detecting vibrations received from at least one optical fiber having perturbations, the apparatus comprising a detection device configured to detect interferometric patterns from Rayleigh scattering from said perturbations, wherein said patterns are of an order of magnitude of 1×10⁻⁴ dB.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram showing an optical fiber connected to a monitoring device to detect vibrations according to embodiments of the present invention;

FIG. 2 is a simplified diagram showing in greater detail the components of the monitoring device;

FIG. 3 is a simplified block diagram showing perturbations introduced to the optical fibers according to embodiments of the present invention;

FIG. 4 is a simplified diagram schematically showing perturbations being introduced by fusion splicing of smaller lengths of optical fiber; and

FIG. 5 is a simplified flow chart showing a procedure for finding an optimal perturbation pattern to obtain an optimal SNR for any given category of vibration according to embodiments of the present invention.

### DESCRIPTION OF SPECIFIC EMBODIMENTS OF THE INVENTION

The present invention, in some embodiments thereof, relates to a system, method and apparatus for distributed vibration sensing and, more particularly, but not exclusively, to a system that uses optical fibers and reflections of the light signal to monitor vibrations.

Optical fiber cables are installed both to provide a protected path for optical fiber communication as well as for detecting vibrations. Installation may include but is not limited to burial underground. An optical fiber for detecting vibrations comprises perturbations at predetermined intervals, the perturbations either being printed in a coating layer around the fiber so that the perturbations are not invasive, or by a chain of repeated fusion splices. The perturbations affect Rayleigh scattering of the light in the fiber which may be detected using a Coherent Optical Time Domain Reflectometer (C-OTDR). Different spacings of the perturbations provide optimized SNR for vibrations from different measurands.

In general, it is cables, not individual fibers, that are installed. In such cables, one or more of the fibers may be adapted with the perturbations in the coating, typically the primary coating, for detecting vibrations. The cable is normally installed or situated with the purpose of providing communication, and detecting vibrations according to the present embodiments is entirely compatible with and does not interfere with the normal use of the cable and all of the fibers for communications.

As opposed to the current art, the invention introduces perturbations of a non-intrusive or structure altering nature to the commercially available communications grade optical fiber as specified in international standards (e.g. IEC 60793-2-50).

For a specific type of vibration, empirical testing is carried out to find a pattern of perturbations that gives a best signal to noise ratio (SNR) for detection of the vibration signal.

Perturbations according to the present embodiments may be added to the fibers using processing equipment which is standard for most optical fiber cable manufacturers. Thus, for example, equipment intended for color-coding of the optical fiber with urethane acrylate inks, laser printing, or for secondary coating of the optical fiber with extrudable polymers may be used to print the perturbations.

Due to the non-intrusive or structure altering nature of the perturbations, the optical fibers may assume a dual-functioning nature and may be used as both vibration sensing optical fibers and as optical communication fibers at the same time. Thus costs are saved in the laying of fibers to form the network.

The perturbations may be spaced at intervals based upon a model that defines spatial resolution to relate the vibrations to spacing of the perturbations in the fiber. For example, detecting vibrations at a spatial resolution of ˜10 m may be achieved with an accuracy of ±1.0 mm per perturbation and spacing between each, and using 2-4 groupings of perturbations per fiber link. More particularly, cyclic or repeated perturbations in the optical fiber may serve to improve the SNR. The spatial resolution may vary as a result. As a by-product, the perturbations may further provide for identifying the specific source of the vibration as a human or a vehicle or the like is an implementational by-product of the invention.

It is noted that—the acoustic energy of the vibrations that the optical fiber is intended to detect may cause strain waves in the optical fiber. Backscattered light from the region of vibration is different from that of no vibration, and therefore can identified by comparing return signals before and during the vibration.

The present embodiments may provide a passive optical system with a positive signal-to-noise ratio (SNR) of the desired reflected optical signal carrying the vibration information at the return end, specifically at the receiver of the interrogator device.

The cable design for use with the present embodiments involves simultaneous coupling of the various elements of the cable, for example fibers, secondary coating, strength, geometrical, jacketing and armoring, such that the elements may act mechanically together as one unit while undergoing the stress and strain typically undergone by cables, thus bending, twisting/torsion and compression when installed and after installation and undergoing low and high temperatures and the like. Traditionally acceptable cable materials such as dielectric strength yarns, metallic armor or longitudinal strength elements may be freely incorporated into the present embodiments using the same engineering considerations required to a standard fiberoptic communications cable.

The system may comprise a Coherent Optical Time Domain Reflectometer (C-OTDR) which monitors discrete and continuous backscattered (Rayleigh) optical power over a communications grade optical fiber for discernable identifiable patterns caused by vibrations and enabled by the induced perturbations of the fiber.

The present embodiments may provide a sensitivity range of up to 100 km of fiber, as opposed to currently achievable lengths of −50 km with existing communication fibers and/or monitoring of non-linear effects.

The system is capable of distinguishing various types of vibrations. Thus vibrations may be caused by humans or animals, or by light or heavy vehicles, or by light or heavy mechanical-engineering activity, or by drilling or hewing activity or by geological activity such as earthquakes, or by equipment for geological characterization of the ground. Each type of vibration may be assigned a specific algorithm at the interrogator once optimal SNR has been achieved in the optical fiber. Machine learning may be used to identify and effectively distinguish between the signatures of different sources of vibration.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

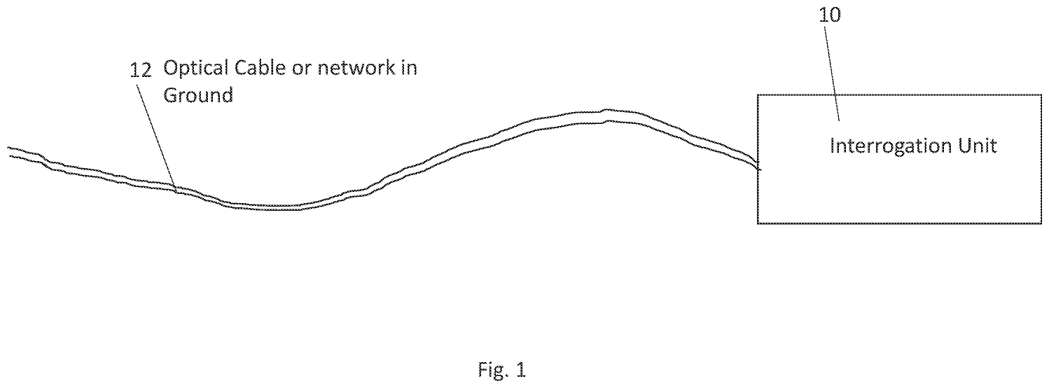

Referring now to the drawings, FIG. 1 illustrates a generalized embodiment of the present invention. An interrogation unit 10 is connected to one or more optical cables 12 situated or installed in proximity to the measurand. The cables 12 include one or more optical fibers with perturbations that are made non-invasively into the cable, meaning that the perturbations do not extend into the mode field diameter of the optical fiber. Rather the perturbations may simply be provided by printing marks on the primary coating of the optical fiber, or afterwards on a pre-heated coating. The perturbations thus do not impinge on the functional photonic energy itself, allowing standard fiberoptic communication to continue, but do affect interferometric Rayleigh scattering of the light, causing specific minute reflections of the scattered light that can be detected and interpreted to detect vibrations. There is thus no interference with the communication signaling, which may proceed unaffected.

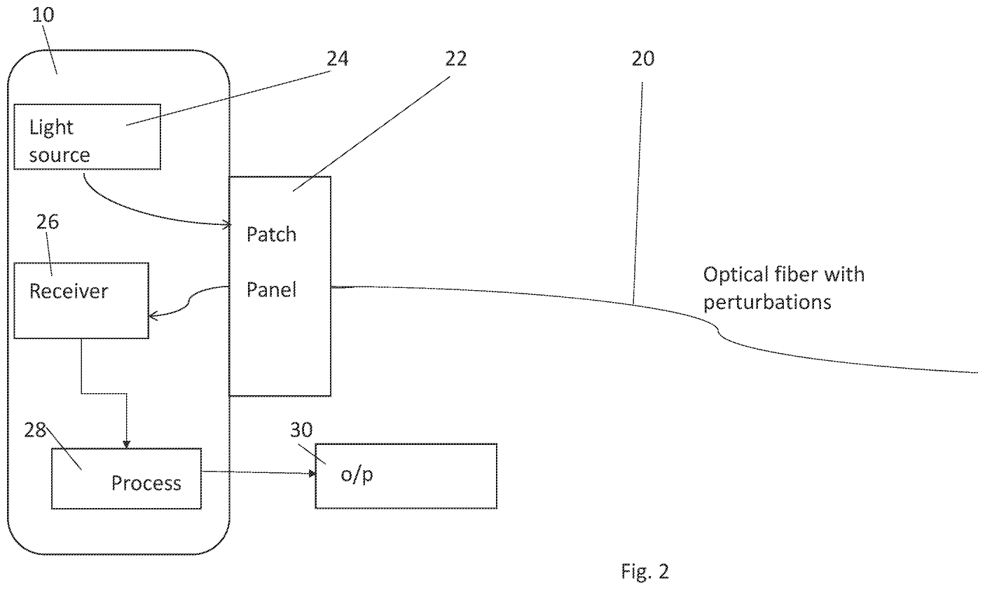

Reference is now made to FIG. 2, which is a simplified diagram illustrating in greater detail the interrogation unit 10 in accordance with the embodiment of FIG. 1. As shown in FIG. 2, optical fiber with perturbations 20 is connected to patch panel 22. The fiber receives light from a light source 24 and the perturbations cause interferometric Rayleigh scattering which reflects back along the fiber and is detected at receiver 26. The reflections are processed to detect and analyze vibrations at processor 28 and the results are reported at output 30. In greater detail, the patch panel 10 provides a mechanical interface for the fiber 20 to the light source and receiver. The interface or connection to the interrogator may be a standard coupling of an optical fiber with a commercially available connector. The coupling may typically be an APC—“Angled Physical Contact” connector.

The interrogation unit connects between the source 24, the fiber 20, and the receiver 26 and processing unit. The receiver 26 may comprise a Coherent Optical Time Domain Reflectometer (C-OTDR) which monitors discrete and continuous backscattered (Rayleigh) optical power over a communications grade optical fiber for discernable identifiable patterns caused by vibrations and enabled by the induced perturbations of the fiber. The system further comprises a reporting interface 28 which can be part of or external to the physical interrogator but may be digitally connected to the receiving and processing unit 26.

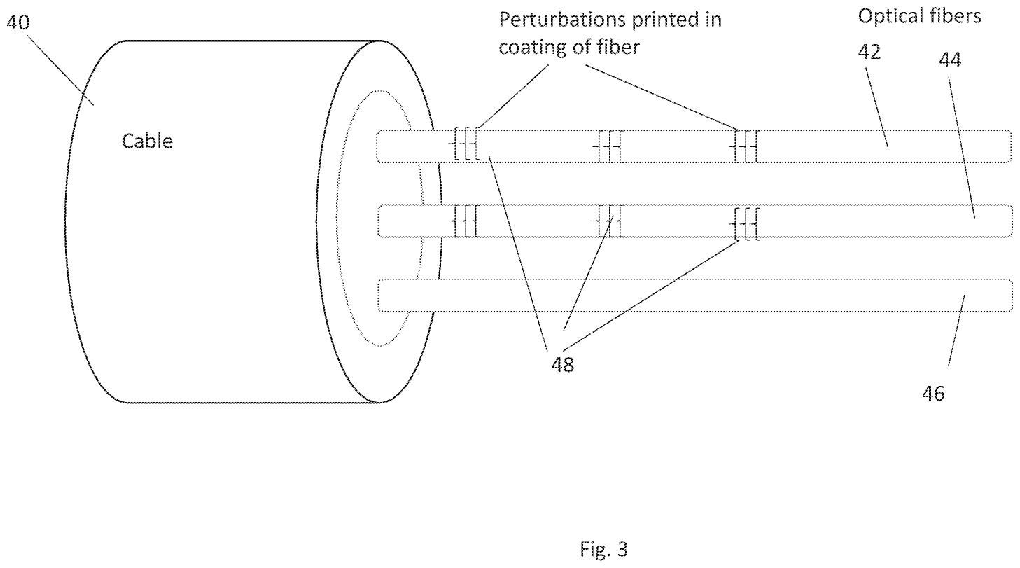

Reference is now made to FIG. 3, which is a simplified diagram illustrating an optical cable 40 having three fibers 42, 44 and 46. Two of the fibers 42 and 44 have been treated with perturbations 48 and the third fiber 46 has not.

The cable is laid in the normal way as part of a communication network. However fibers 42 and 44 take on the additional task of detecting vibrations.

The cable 40 consists of an outer protective jacket 50. The cable may include other protective materials as known in the art, and contains the optical fibers mentioned. Some of the fibers (two in the example shown) have been pre-treated to include the perturbations. The perturbations are as defined by the specific model required. The model is discussed in greater detail hereinbelow.

As illustrated, the perturbations are arranged in groups, so that there is a small pre-determined spacing between perturbations within a group and a larger pre-determined spacing between groups. The number of perturbations in each group is shown as three, but this is purely by way of example, and the number of groups may depend on the length of the fiber. In particular, the entire length of the fiber may be treated or just sections of the fiber that pass through areas of interest depending on the specific nature of the measurand. Thus, there is a repeated number of groupings of perturbations, wherein the perturbations are equidistant within each group and there are a number of equidistant groups of perturbations.

In an embodiment, the perturbations are markings which are made on the primary coating, and a tight buffer is provided on the secondary coating. Typically the tight buffer is a circular concentric layer of an extrudable polymer (e.g. PVC, PE, Polyester) applied to the optical fiber as a secondary coating with an outer diameter range of 600-900 μm. The perturbations may be made during the course of coloring or coating the optical fiber.

More particularly, there are a number of technologies that may be used to color, mark or print either directly on the primary coating of optical fibers, for example urethane acrylate inking, laser printing, or on secondary coatings, for example on the tight buffers. These technologies are referred to as non-invasive perturbation and are, in effect, the reason that the optical fibers may continue to fulfil their communication function. The optical fibers with the perturbations may minutely but measurably affect the characteristics of the photonic energy/optical signals as they travel along an optical fiber, while not causing any aberration that physically impacts the geometry or mechanical properties of the medium upon which they are implemented.

Some examples of perturbation technology that may be used in the present embodiments include:
Urethane acrylate inking (using UV curing) on primary coating of optical fibers;
Ink-jet printing on extruded polymer that constitutes the tight buffer (often 900 μm diameters, sometimes 600 μm diameters);
Offset printing on extruded polymer that constitutes the tight buffer;
Laser printing on primary coating of optical fibers
Indentation printing on extruded polymer that constitutes the tight buffer; and
Automated fusion splicing
Variants of the last 2 that involved pre-heating to mark an already cooled (no longer molten) secondary coating.

The perturbations may more generally be any kind of marking that may cause interferometric Rayleigh scattering and any kind of printing, such as embossing, and offset may be used, as long as there is sufficient resolution. Sufficient resolution relates to the level of accuracy required at the specific location and the types and locations of vibrations expected.

The specific parameters of the algorithm of the interogator (spatial resolution, amplitude, signal width etc.) are adapted to the specific type of vibration of interest (the measurand). Thus the algorithm is configured in one way to detect humans and animals, and in another way to detect small vehicles. The algorithm is configured differently again to detect large vehicles and differently again to detect tractors and like equipment. Thus each different type of measurand has a template (i.e. algorithm) of its own.

The optical fiber may be silica/silica single mode communications grade as per the IEC 60793-2-50 standard or a similar facsimile.

The perturbations may be achieved using UV-curable urethane acrylate inks, including any of polyether based, polyester based, polyalkane based and polycarbonate based inks.

The perturbations may be achieved using secondary coating extrudable polymers, including PVC, Nylon, highly loaded PE (flame retardant and/or low smoke and/or zero halogen), polyurethane, polyester elastomer, PBT, and fluoropolymers.

The perturbations may be achieved through the use of fiber splices, including mechanical splicing and fusion splicing.

As shown, two vibration sensing fibers are shown in FIG. 3 but other configurations are possible. Configurations in general may include the following:

Number of vibration sensing fibers per cable
1—minimum without redundancy
2—minimum with redundancy
4—dual source with redundancy
6—triple source with redundancy
8—quadruple source with redundancy
12—six sources with redundancy

Nominal wavelengths used in embodiments for monitoring of interferometric Rayleigh scattering may include 1550 nm and 1625 nm.

Typical Light sources for use with the present embodiments include Fabry-Perot (FP) lasers and distributed feedback (DFB) lasers and Narrow-Spectral Width lasers.

In the above, a model is mentioned for obtaining the spacings for the perturbations. In considering the conceptual boundaries of the model, first of all the embodiments may make use of standard communications grade optical fibers. As such, an intrinsically well-known mechanism that operates in optical fibers is Rayleigh Scattering, which may loosely be defined as the predominantly elastic scattering of light or other electromagnetic radiation by particles much smaller than the wavelength of the radiation”.

As the skilled person will be aware, in optical fibers, intrinsic Rayleigh Scattering is the main contributor to attenuation of the optical signal, and may be measured using standard test equipment. The conventional measurement is at a level that detects ongoing pulses/signals at a sampling rate, the pulse spacing, that is not relevant for detection of vibrations. The present embodiments by contrast make use of Rayleigh Scattering that is sampled continuously and is too small to be noticed by the attenuation measurement, and indeed cannot generally be detected by standard test equipment. The present embodiments however use a model that ensures that the source signal is strong enough to provide a positive SNR (signal to noise ratio) to enable detection at the monitoring end. The result is a signal that is not too strong to interfere with or be confused with attenuation measurement, but not too weak to be indistinguishable by the monitoring equipment.

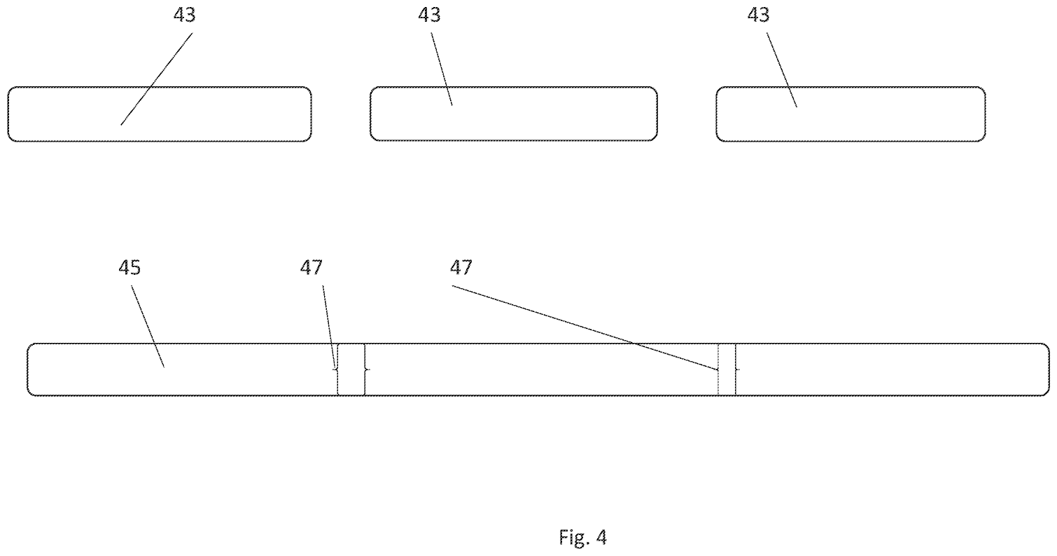

Reference is now made to FIG. 4, which illustrates an alternative embodiment according to the present invention for introducing perturbations into an optical fiber that may cause interferometric Rayleigh scattering on the minute scale.

Lengths of optical fiber 43 are obtained and fused together using fusion splicing to form a continuous optical fiber 45. The points at which the fiber lengths are spliced together have perturbations 47 that cause interferometric Rayleigh scattering at the minute scale as discussed above. The perturbations are created when short lengths of an optical fiber with similar but not exactly the same Effective Group Index of Refraction (N_{eff}) are introduced into the continuous length of spooled fiber through the use of fusion splices. The differences in the N_{eff} between the introduced short fiber length and that of the otherwise continuous spooled fiber are in the order of 7.5±2.5×10⁻⁴ (N_{eff} is unitless).

The lengths between splices are chosen as discussed elsewhere herein to match the vibrations it is intended to detect. The obtained lengths 43 are selected accordingly.

In practice, the operator is most likely to start with a full length production spool of communications grade optical fiber (typically 50 km). At predetermined points chosen according to the vibrations being monitored, the fiber is cut and a short length of a different fiber having a very slightly different Effective Group Index of Refraction is inserted. The short length is jointed to the spooled fiber with fusion splicing.

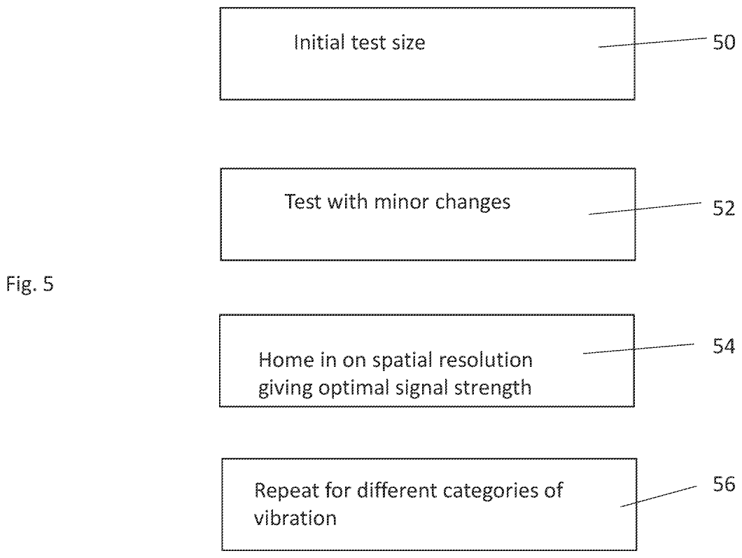

Reference is now made to FIG. 5 which illustrates in flow chart form an algorithmic or qualitative staged approach for obtaining parameters according to the model for printing the perturbations.

In box 50—an initial calculated test perturbation is imparted on a fiber which is then tested in the field with the size of vibration in question—an example may be two perturbations every 10 meters.

In box 52—the results are noted and minor changes in size of the perturbation parameters are tested, and used for calculation of an optimal spatial resolution.

In box 54—the testing is continued for that size vibration until an optimal signal strength is achieved.

The process is carried out separately—box 56—for each different classification of vibration, since the optimal value changes based on what is monitored, and in embodiments, also for location of the vibration source (measurand) at different resolution. For example, interrogator algorithm gives the ideal signal strength required to detect vibrations of a 10-ton truck 15 meters from the optical fiber, and a different interrogator algorithm is required to detect vibrations from a human being two meters from the fiber. Each detection template is thus finalized by trial and error.

Two such optical fibers at right angles may be used to locate a vibration source to a required level of accuracy.

It is expected that during the life of a patent maturing from this application many relevant optical fibers and detectors will be developed and the scopes of the related and other terms used herein are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An optical fiber for use in distributed vibration sensing, the optical fiber comprising perturbations, the perturbations being imparted either externally to a mode field diameter of the optical fiber or through the use of fusion splicing of fiber lengths to form said optical fiber, the perturbations being spaced apart using spacings, which spacings are selected to amplify minute interferometric Raleigh scattering.

2. The optical fiber of claim 1, wherein said perturbations are imparted in groups of at least one perturbation, each group equidistantly spaced along said fiber at a first, inter-group, spacing.

3. The optical fiber of claim 2, wherein each group comprises a plurality of equidistant perturbations spaced apart at a second, intragroup, spacing.

4. The optical fiber of claim 3, wherein at least one of said inter-group and intragroup spacings comprises said spacings selected to amplify minute interferometric Raleigh scattering, or wherein at least one of said inter-group spacing and said intragroup spacing is selected using empirical testing to maximize a reflected signal from minute interferometric Rayleigh scattering in the presence of a given vibration.

5. (canceled)

6. The optical fiber of claim 53, wherein at least one of said inter-group spacing and said intragroup spacing is selected using empirical testing to maximize a reflected signal from minute interferometric Rayleigh scattering in the presence of a given vibration, and said vibration is one member of the group consisting of:
humans, animals, light vehicles, heavy vehicles, light mechanical-engineering activity, heavy mechanical engineering activity, drilling, and geological activity.

7. The optical fiber of claim 1, wherein said imparting of said perturbations comprises printing.

8. The optical fiber of claim 7, wherein said perturbations are laser printed, or wherein said perturbations are imparted into a coating layer of said fiber.

9-11. (canceled)

12. Apparatus for detecting vibrations comprising:
at least one optical fiber having perturbations external to a mode field diameter of said optical fiber; and
a detection device configured to detect Rayleigh scattering from said perturbations, said perturbations being separated by spacings, said spacings being selected to amplify minute interferometric Raleigh scattering.

13. (canceled)

14. Apparatus according to claim 12, wherein said perturbations are imparted in groups equidistantly spaced along said fiber at a first, inter-group, spacing.

15. Apparatus according to claim 14, wherein each group comprises a plurality of equidistant perturbations spaced apart at a second, intragroup, spacing.

16. Apparatus according to claim 15, wherein at least one of said first and said second spacings comprises said spacings selected to amplify minute interferometric Raleigh scattering.

17. Apparatus according to claim 12, wherein at least one of said inter-group spacing and said intragroup spacing is selected using empirical testing to maximize the SNR of a reflected signal from Rayleigh scattering in the presence of a given vibration, or wherein at least one of said inter-group spacing and said intragroup spacing is selected using empirical testing to maximize the SNR of a reflected signal from Rayleigh scattering in the presence of a vibration obtained from one member of the group consisting of: humans, animals, light vehicles, heavy vehicles, light mechanical-engineering activity, heavy mechanical engineering activity, drilling, and geological activity.

18. (canceled)

19. Apparatus according to claim 17, comprising a plurality of optical fibers, wherein at least one fiber comprises a spacing selected for one member of said group and another of said fibers comprises a spacing selected for one other member of said group.

20. Apparatus according to claim 12, wherein said perturbations are imparted by printing into a coating of said fiber.

21. Apparatus according to claim 20, wherein said printing comprises laser printing, or wherein said coating is a primary coating of said fiber.

22. (canceled)

23. Apparatus according to claim 12, wherein said at least one optical fiber is constructed by splicing together of smaller fibers of predetermined lengths, the perturbations imparted by said fusion splicing.

24. A method of producing an optical fiber for detection of vibrations from Rayleigh scattering, the method comprising:
coating of a fiber with a primary coating, and
printing perturbations into said primary coating, said perturbations being printed at spacings, said spacings being selected to amplify minute interferometric Raleigh scattering.

25. The method of claim 24, wherein said printing is carried out while said primary coating is still hot from the coating process, or wherein said printing is carried out while said primary coating is heated following said coating process.

26. (canceled)

27. The method of claim 24, comprising printing said perturbations in groups equidistantly spaced along said fiber at a first, inter-group, spacing, and wherein each group comprises a plurality of equidistant perturbations spaced apart at a second, intragroup, spacing.

28. The method of claim 24, wherein said printing into said primary coating comprises laser printing.

29. (canceled)

30. The method of claim 24, comprising introducing perturbations into said optical fiber at predetermined spacings by fusion splicing.

31. (canceled)

32. The method of claim 30, wherein at least one of said inter-group spacing and said intragroup spacing is selected using empirical testing to maximize the SNR of a reflected signal from Rayleigh scattering in the presence of a given vibration.

33. (canceled)

34. The method of claim 24, further comprising detecting vibrations over an area by:
burying said optical fiber in said area; and
connecting to said optical fiber a Coherent Optical Time Domain Reflectometer (C-OTDR) to detect Rayleigh scattering of light travelling through said optical fiber.

35. Apparatus according to claim 12, wherein the detection device is configured to detect interferometric patterns from Rayleigh scattering from said perturbations, wherein said patterns are of an order of magnitude of 1×10⁻⁴ dB.
